(19) United States
(12) Patent Application Publication
(10) Pub. No.: US 2019/0200378 A1
(43) Pub. Date: Jun. 27, 2019

(54) OPERATION METHOD OF COMMUNICATION NODE FOR UPLINK TRANSMISSION IN COMMUNICATION NETWORK

(71) Applicant: ELECTRONICS AND TELECOMMUNICATIONS RESEARCH INSTITUTE, Daejeon (KR)

(72) Inventors: Young Jo KO, Daejeon (KR); Gi Yoon PARK, Daejeon (KR); Ok Sun PARK, Daejeon (KR); Seung Kwon BAEK, Daejeon (KR); Woo Ram SHIN, Daejeon (KR); Chan Ho YOON, Daejeon (KR)

(21) Appl. No.: 16/223,502

(22) Filed: Dec. 18, 2018

(30) Foreign Application Priority Data
Dec. 21, 2017 (KR) 10-2017-0176840
Dec. 28, 2017 (KR) 10-2017-0182490

(51) Int. Cl. H04W 72/12; H04W 72/04

(52) U.S. Cl. CPC H04W 72/1268; H04W 72/042; H04W 72/121; H04W 72/1284; H04W 72/044

(57) ABSTRACT

An operation method of a terminal for uplink transmission in a communication network based on Internet of things (IoT) includes receiving a message including information on a resource pool for the uplink transmission from a base station included in the communication network; configuring an uplink resource for the uplink transmission based on the resource pool; transmitting a message including a transmission indicator indicating the uplink transmission to the base station based on a transmission indicator pool corresponding to the resource pool; and performing the uplink transmission through the uplink resource based on a plurality of parameters preconfigured for the uplink transmission.

### CROSS-REFERENCE TO RELATED APPLICATIONS

This application claims priority to Korean Patent Application Nos. 10-2017-0176840, filed Dec. 21, 2017, and 10-2017-0182490, filed Dec. 28, 2017, in the Korean Intellectual Property Office (KIPO), the entire contents of which are hereby incorporated by reference.

### BACKGROUND

### 1. Field of the Invention

The present disclosure relates to an operation method of a communication node for uplink transmission in a communication network, more specifically, to an operation method of a communication node for uplink transmission in an Internet of things (IoT) based communication system.

### 2. Description of Related Art

The communication network may comprise a core network (e.g., a mobility management entity (MME), a serving gateway (SGW), a packet data network (PDW), and the like), base stations (e.g., macro cell base stations, small cell base stations, relays, and the like), a terminal, and the like. The communications between the base station and the terminal may be performed using various radio access technologies (RATs) (e.g., 4G communication technologies, 5G communication technologies, wireless broadband (WiBro) technologies, wireless local area network (WLAN) technologies, wireless personal area network (WPAN) technologies, and the like).

In the communication network, the terminal should be allocated a resource for performing communications from the base station to perform the communications with the base station. In order to perform the communications with the base station in the communication network, the terminal may receive information on a transmission format such as the size of data (e.g., a payload size, a modulation and coding scheme (MCS), and the like). In this way, the terminal may perform the communications with the base station based on the information on the transmission format received from the base station.

Recently, the 3^{rd} generation partnership project (3GPP) is studying autonomous transmission by terminals as an effective method for supporting connectivity of a large number of Internet of things (IoT) based terminal in the 5G system. More specifically, in the case of the autonomous transmission, when data to be transmitted occurs in the terminal, the terminal may not transmit the data based on a preconfigured resource pool without performing a request for uplink scheduling for transmitting the data to the base station.

In general, the resource pool may include a plurality of orthogonal resources. Specifically, the orthogonal resources may be resources having orthogonality, which mean resources that do not interfere with each other. For example, a plurality of subcarriers used in an orthogonal frequency division multiple access (OFDMA) scheme may be referred to as the orthogonal resources that do not interfere with each other. On the other hand, the resource pool may include a plurality of non-orthogonal resources. Specifically, the non-orthogonal resource may mean resources that do not have orthogonality, and may mean resources that interfere with each other. For example, a sequence used for transmission in the same time and frequency region in an asynchronous code division multiple access (CDMA) scheme may be the non-orthogonal resource.

As described above, a plurality of terminals included in the communication network may perform communications with the base station based on the resource pool preconfigured by the base station. However, when the plurality of terminals included in the communication network communicate with the base station based on the same resources included in the preconfigured resource pool, there is a problem that a collision occurs between the resources used for communications. Also, when the plurality of terminals included in the communication network communicate with the base station based on the same resources, there is a problem that a load for supporting the communications between the plurality of terminals occurs in the base station.

Meanwhile, when uplink data exists in the terminal, the terminal may transmit a message requesting uplink data scheduling to the base station. The base station may receive the message requesting uplink data scheduling from the terminal, and may transmit an uplink grant (e.g., scheduling information) to the terminal in response to the message. When the uplink grant is received from the base station, the terminal may transmit the uplink data to the base station using a resource allocated by the base station.

In the case that the autonomous transmission (e.g., non-orthogonal uplink transmission) is supported in the communication network, the terminal may transmit the uplink data to the base station without the uplink grant. For example, the terminal may select a resource in the preconfigured resource pool and transmit the uplink data to the base station using the selected resource. Here, the preconfigured resource pool may be shared by the base station and a plurality of terminals. Since the terminal may not know resources used by other terminals, the resource selected by the terminal in the preconfigured resource pool may be overlapped with the resources used by other terminals. In this case, a plurality of terminals may transmit the uplink data using the same resource (e.g., non-orthogonal resource), thereby causing a transmission collision. Therefore, a scheme to solve the collision problem of uplink data in the autonomous transmission procedure will be needed.

### SUMMARY

Accordingly, embodiments of the present disclosure provide an operation method of a communication node for uplink transmission in an IoT based communication network.

Accordingly, embodiments of the present disclosure also provide a method and an apparatus for transmitting an uplink signal based on a spreading scheme in a communication network.

In order to achieve the objective of the present disclosure, an operation method of a terminal for uplink transmission in a communication network based on Internet of things (IoT) may comprise receiving a message including information on a resource pool for the uplink transmission from a base station included in the communication network; configuring an uplink resource for the uplink transmission based on the resource pool; transmitting a message including a transmission indicator indicating the uplink transmission to the base station based on a transmission indicator pool corresponding to the resource pool; and performing the uplink transmission through the uplink resource based on a plurality of parameters preconfigured for the uplink transmission.

The message including information on a resource pool may be received from the base station through a radio resource control (RRC) signaling.

The resource pool includes time-frequency resources available for the uplink transmission of the terminal.

The plurality of parameters may include a timing of the uplink transmission, a transmission power of the uplink transmission, a size of a payload of the uplink transmission, and a modulation and coding scheme (MCS) for the uplink transmission.

The plurality of parameters may be preconfigured by the base station, or at least one parameter among the plurality of parameters may be configured by the terminal.

The at least one parameter may include at least one of a timing of the uplink transmission, a transmission power of the uplink transmission, and a size of a payload of the uplink transmission.

The transmitting may comprise selecting a transmission indicator resource for transmission of the transmission indicator in the transmission indicator pool; and transmitting the message including the transmission indicator to the base station through the transmission indicator resource.

The transmission indicator pool may be acquired from the base station, and may include time-frequency resources available for transmission of the transmission indicator.

The operation method may be performed periodically according to a periodicity preconfigured by the base station, or performed when the uplink transmission is necessary.

In order to achieve the objective of the present disclosure, an operation method of a base station for uplink transmission in a communication network based on Internet of things (IoT) may comprise generating a resource pool for uplink transmission of a terminal included in the communication network and a transmission indicator pool corresponding to the resource pool; transmitting a message including information on the resource pool and information on the transmission indicator pool to the terminal; receiving a message including a transmission indicator indicating the uplink transmission from the terminal; and supporting the uplink transmission of the terminal based on an uplink resource included in the resource pool and a plurality of parameters preconfigured for the uplink transmission.

The resource pool includes time-frequency resources available for the uplink transmission.

The plurality of parameters may include a timing of the uplink transmission, a transmission power of the uplink transmission, a size of a payload of the uplink transmission, and a modulation and coding scheme (MCS) for the uplink transmission.

The plurality of parameters may be preconfigured by the base station, or at least one parameter of a timing of the uplink transmission, a transmission power of the uplink transmission, and a size of a payload of the uplink transmission may be configured by the terminal among the plurality of parameters.

The supporting may comprise identifying an uplink resource indicated by the transmission indicator in the resource pool; and receiving a message including data from the terminal through the identified uplink resource based on the plurality of parameters.

The operation method may be performed periodically according to a periodicity preconfigured by the base station, or performed when the uplink transmission is necessary at the terminal.

In order to achieve the objective of the present disclosure, an operation method of a terminal for uplink transmission in a communication network based on Internet of things (IoT) may comprise receiving a downlink control information (DCI) transmitted from a base station included in the communication network; identifying a terminal group indicated by the DCI based on scrambling of the DCI; and performing uplink transmission of the terminal when the identified terminal group is a terminal group to which the terminal belongs.

The identifying may comprise descrambling the DCI based on an identifier of the terminal group to which the terminal belongs; and identifying the terminal group indicated by the DCI based on a result of the descrambling.

The identifier of the terminal group may be a radio network temporary identifier (RNTI) of the terminal group.

The performing uplink transmission may comprise identifying an uplink resource for the uplink transmission of the terminal from the DCI; and performing the uplink transmission of the terminal through the identified uplink resource based on a plurality of parameters preconfigured for the uplink transmission of the terminal.

The plurality of parameters may include a signature used for the uplink transmission of the terminal, a transmission power of the uplink transmission of the terminal, a size of a transport block for the uplink transmission of the terminal.

According to the embodiments of the present disclosure, it is made possible to efficiently utilize resources for a communication node that performs uplink transmission in the IoT based communication network, thereby reducing a load occurring in the communication network. According to the embodiments of the present disclosure, modulated symbols for uplink data are spread based on an orthogonal spreading sequence, and the spread symbols resulting from the spreading operation can be transmitted to the base station. When a plurality of terminals transmit the spread symbols to which the orthogonal spreading sequences are applied using the same time-frequency resource, the base station can identify the uplink data of each of the plurality of terminals using the orthogonal spreading sequence. Therefore, reception performance can be improved in the non-orthogonal uplink transmission procedure.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram illustrating a first embodiment of a communication system;

FIG. 2 is a block diagram illustrating a first embodiment of a communication node constituting a communication system;

FIG. 3 is a flow chart illustrating an operation method of a communication node for uplink transmission in a communication network according to an embodiment of the present disclosure;

FIG. 4 is a flow chart illustrating a method of transmitting a transmission indicator in a communication network according to an embodiment of the present disclosure;

FIG. 5 is a flow chart illustrating an operation method of a communication node for uplink transmission in a communication network according to another embodiment of the present disclosure;

FIG. 6 is a flow chart illustrating a method of supporting uplink transmission of a terminal in a communication network according to another embodiment of the present disclosure;

FIG. 7 is a flow chart illustrating an operation method of a communication node for uplink transmission in a communication network according to yet another embodiment of the present disclosure;

FIG. 8 is a flow chart illustrating a method of identifying a terminal group in a communication network according to yet another embodiment of the present disclosure;

FIG. 9 is a flow chart illustrating a method for performing uplink transmission of a terminal in a communication network according to yet another embodiment of the present disclosure;

FIG. 10 is a conceptual diagram illustrating a first embodiment of a payload of a communication network according to an embodiment of the present disclosure;

FIG. 11 is a conceptual diagram illustrating a first embodiment of a channel coding process in a communication network according to an embodiment of the present disclosure;

FIG. 12 is a conceptual diagram illustrating a second embodiment of a payload of a communication network according to an embodiment of the present disclosure;

FIG. 13 is a conceptual diagram illustrating a second embodiment of a channel coding process in a communication network according to an embodiment of the present disclosure;

FIG. 14 is a block diagram illustrating a first embodiment of a terminal constituting a communication network;

FIG. 15 is a conceptual diagram illustrating a first embodiment of a spreading based non-orthogonal uplink transmission method;

FIG. 16 is a conceptual diagram illustrating a second embodiment of a spreading based non-orthogonal uplink transmission method;

FIG. 17 is a conceptual diagram illustrating a third embodiment of a spreading based non-orthogonal uplink transmission method; and

FIG. 18 is a conceptual diagram illustrating a fourth embodiment of a spreading based non-orthogonal uplink transmission method.

### DETAILED DESCRIPTION OF THE INVENTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in greater detail with reference to the accompanying drawings. To facilitate overall understanding of the present invention, like numbers refer to like elements throughout the description of the drawings, and description of the same component will not be reiterated.

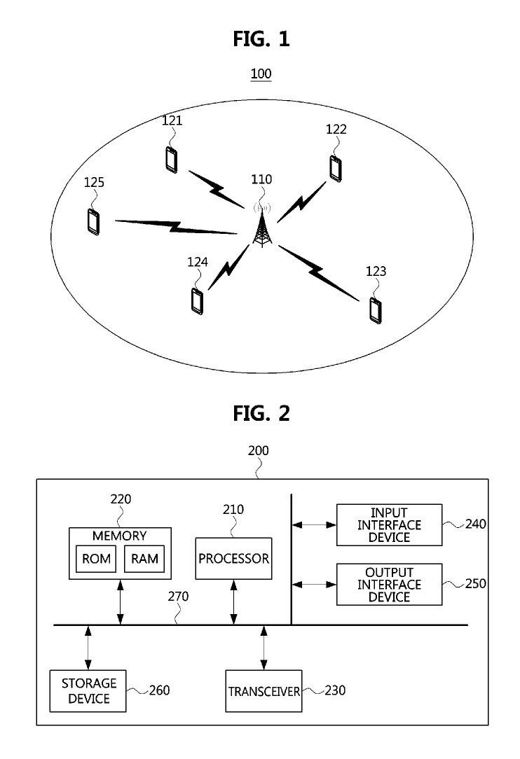

FIG. 1 is a conceptual diagram illustrating a first embodiment of a communication system.

Referring to FIG. 1, a communication system 100 may comprise a plurality of communication nodes 110, 121, 122, 123, 124, and 125. Also, the communication system 100 may further comprise a core network (e.g., a serving-gateway (S-GW), a packet data network (PDN) gateway (P-GW), a mobility management entity (MME), and the like). The plurality of communication node may support 4G communication technologies (e.g., a long term evolution (LTE), LTE-advanced (LTE-A), or the like), 5G communication technologies (e.g., a new radio (NR), or the like), or the like.

Each of the plurality of communication nodes may support at least one communication protocol. For example, each of the plurality of communication nodes may support at least one communication protocol among a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, an orthogonal frequency division multiple access (OFDMA) based communication protocol, a cyclic prefix OFDM (CP-OFDM) based communication protocol, a discrete Fourier transform spread OFDM (DFT-s-OFDM) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, and a space division multiple access (SDMA) based communication protocol. Each of the plurality of communication nodes may have the following structure.

Each of the plurality of communication nodes 110, 121, 122, 123, and 124 may have the following structure.

FIG. 2 is a block diagram illustrating a first embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270. However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, in the communication network 100, the base station 110 may form a macro cell or a small cell, and may be connected to the core network through an idle backhaul or a non-ideal backhaul. The base station 110 may transmit signals received from the core network to the corresponding terminals 121, 122, 123, 124, and 125 and transmit signals received from the terminals 121, 122, 123, 124, and 125 to the core network. The plurality of terminals 121, 122, 123, 124, and 125 may belong to the cell coverage of the base station 110. The plurality of terminals 121, 122, 123, 124 and 125 may be connected to the base station 110 by performing a connection establishment procedure with the base station 110. The plurality of terminals 121, 122, 123, 124, and 125 may communicate with the base station 110 after being connected to the base station 110.

Also, the base station 110 may perform multi-input multi-output (MIMO) transmission (e.g., single user (SU) MIMO (SU-MIMO), multi user (MU) MIMO (MU-MIMO), massive MIMO etc.), coordinated multipoint (CoMP) transmission, transmission in an unlicensed band, device to device (D2D) communication (D2D) (or, proximity services (ProSe)), and the like. Each of the plurality of terminals 121, 122, 123, 124, and 125 may perform operations corresponding to those of the base station 110, operations supported by the base station 110, and the like.

Here, the base station 110 may refer to a Node B (NodeB), an evolved Node B (eNodeB), a base transceiver station (BTS), a radio remote head (RRH), a transmission reception point (TRP), a radio unit (RU), a roadside unit (RSU), a radio transceiver, an access point, an access node, or the like. Each of the plurality of terminals 121, 122, 123, 124, and 125 may be a user equipment (UE), an access terminal, a mobile terminal, a station, a subscriber station, a mobile station, a portable subscriber station, a node, a device, an on-broad unit (OBU), or the like.

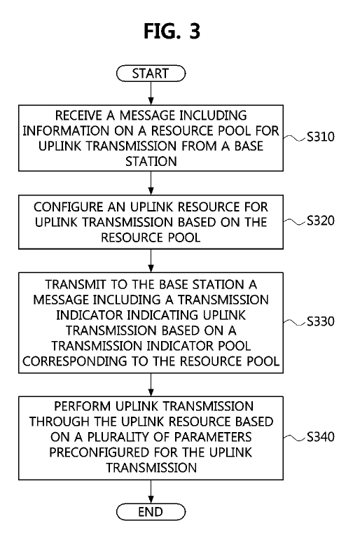

FIG. 3 is a flow chart illustrating an operation method of a communication node for uplink transmission in a communication network according to an embodiment of the present disclosure.

Referring to FIG. 3, a communication network according to an embodiment of the present disclosure may be a communication network based on Internet of things (IoT). The IoT based communication network may have a relatively small frequency of uplink transmissions compared to the conventional communication network such as the LTE. There are two main types of traffics in the IoT based communication networks.

Specifically, the traffics of the IoT based communication network may be classified into mobile autonomous reporting (MAR) traffic and network command (NC) traffic. The MAR traffic may refer to traffic according to an autonomous report from a terminal, which is a communication node included in the IoT based communication network, and refer to traffic generated in the process of reporting periodically or aperiodically to a base station. Also, the NC traffic may refer to traffic generated by a command transmitted from a server (e.g., an application server) included in the IoT based communication network, and a response of the terminal for the NC traffic may not be needed.

Also, the traffic generated in the IoT based communication network may not have a relatively high requirement for the delay of the data transmission compared to the traffic generated in the communication network such the LTE. However, when a plurality of terminals attempt to perform uplink transmissions to the base station simultaneously in the IoT based communication network, a heavy load for supporting the uplink transmissions of the plurality of terminals may occur at the base station. Accordingly, a method for controlling traffic related to uplink transmissions may be required in the IoT based communication network. Accordingly, an operation method of a communication node according to an embodiment of the present disclosure may support efficient uplink transmission in the IoT based communication network.

First, a communication node performing an operation method according to an embodiment of the present disclosure may be a terminal performing uplink transmission in the IoT based communication network. Also, the terminal performing an operation method according to an embodiment of the present disclosure may have a structure similar to or the same as that of the communication node described with reference to FIG. 2. In the communication network according to an embodiment of the present disclosure, the terminal may receive a message including information on a resource pool for uplink transmission from the base station included in the communication network (S310). For example, the message including information on the resource pool, which is received from the base station, may be received through a radio resource control (RRC) signaling.

Then, the terminal may configure an uplink resource for uplink transmission based on the resource pool for uplink transmission (S320). For example, the resource pool may include time-frequency resources indicating uplink resources available for uplink transmission in the terminal. That is, the terminal may configure a time-frequency resource used for uplink transmission based on the time-frequency resources included in the resource pool as the resources available for uplink transmission.

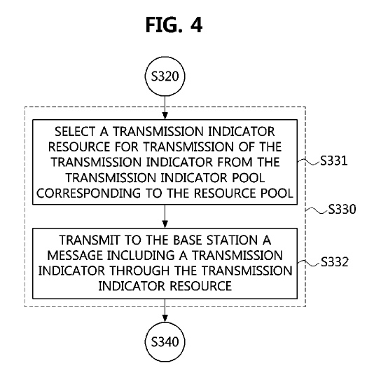

Then, the terminal may transmit a message including a transmission indicator indicating its uplink transmission to the base station, based on a transmission indicator pool corresponding to the resource pool (S330). Here, the transmission indicator transmitted from the terminal may be an indicator indicating that the terminal is to perform the uplink transmission. Also, the transmission indicator pool may include time-frequency resources available for transmission of the transmission indicator, which may be acquired in advance from the base station. A concrete method of transmitting the message including the transmission indicator to the base station at the terminal will be described with reference to FIG. 4.

FIG. 4 is a flow chart illustrating a method of transmitting a transmission indicator in a communication network according to an embodiment of the present disclosure.

Referring to FIG. 4, in the communication network according to an embodiment of the present disclosure, the terminal may select a transmission indicator resource for transmission of the transmission indicator indicating the uplink transmission in the transmission indicator pool corresponding to the resource pool (S331). That is, before performing the uplink transmission, the terminal may select a time-frequency resource, which is a transmission indicator resource for transmitting the transmission indicator, in the transmission indicator pool.

Then, the terminal may transmit a message including the transmission indicator to the base station through the transmission indicator resource (S332). Specifically, the terminal may generate the message including the transmission indicator, and may transmit the message including the transmission indicator to the base station using the time-frequency resource selected as the transmission indicator resource.

Referring again to FIG. 3, in the communication network according to an embodiment of the present disclosure, the terminal may perform the uplink transmission based on a plurality of parameters previously configured for the uplink resource and the uplink transmission (S340). Here, the plurality of parameters may be parameters for the uplink transmission of the terminal, and may be preconfigured by the base station. For example, the plurality of parameters may include an uplink transmission timing, an uplink transmission power, a payload size, and a modulation and coding scheme (MCS).

Here, the plurality of parameters are described as being configured in advance by the base station, but embodiments of the present disclosure are not limited thereto. That is, at least one of the plurality of parameters may be configured by the terminal. The at least one parameter configurable by the terminal among the plurality of parameters may be at least one of the uplink transmission timing, the uplink transmission power, and the payload size.

For example, when the terminal itself configures the uplink transmission timing among the at least one parameter, the terminal may configure the uplink transmission timing by applying a preset offset based on the downlink reception timing. Also, when the terminal itself configures the uplink transmission power among the at least one parameter, the terminal may configure the uplink transmission power based on an open loop power control according to a downlink reception path loss. Also, when the terminal itself configures the payload size among the at least one parameter, the terminal may configure the payload size based on the amount of data transmitted from the terminal.

The terminal performing the operation method according to an embodiment of the present disclosure may perform the uplink transmission periodically with a periodicity preconfigured by the base station. Also, the terminal may perform the uplink transmission non-periodically when the uplink transmission is necessary. That is, the operation method of a communication node for uplink transmission according to an embodiment of the present disclosure may be performed periodically or non-periodically.

Meanwhile, in the communication network according to an embodiment of the present disclosure, the terminal may generate a message including data, and may transmit the message including the data to the base station. Accordingly, the base station may receive the message including the data from the terminal. Thereafter, the base station may transmit an acknowledgement (ACK) message or a negative acknowledgment (NACK) message to the terminal based on whether or not the message including the data has been successfully received from the terminal.

Then, when the terminal receives the ACK message from the base station in response to the transmission of the message including the data, the terminal may determine that the data transmission has been completed successfully. On the other hand, when the terminal receives the NACK message from the base station in response to the transmission of the message including the data, the terminal may determine that the data transmission has failed and may retransmit the message including the data to the base station.

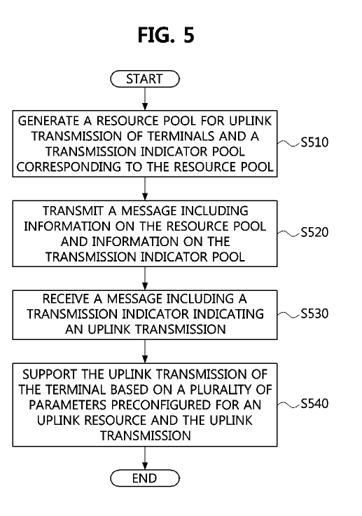

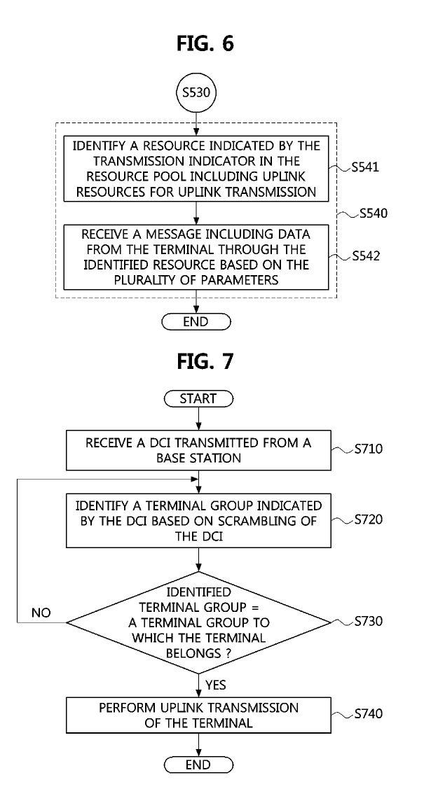

Hereinafter, an operation method performed in a base station in accordance with the operation method according to the embodiment of the present disclosure described with reference to FIGS. 3 and 4 will be described. That is, an operation method of a communication node for uplink transmission in a communication network according to another embodiment of the present disclosure, which will be described below with reference to FIGS. 5 and 6, may refer to an operation method of a base station.

However, an operation method of a base station for uplink transmission in a communication network according to another embodiment of the present disclosure, which will be described referring to FIGS. 5 to 6, may not necessarily be performed as corresponding the respective operations of the embodiment described referring to FIGS. 3 to 4, and may mean an embodiment of each operation which can be performed as an operation method of a base station.

FIG. 5 is a flow chart illustrating an operation method of a communication node for uplink transmission in a communication network according to another embodiment of the present disclosure.

Referring to FIG. 5, a communication network according to another embodiment of the present disclosure may be the same as the communication network described with reference to FIGS. 3 and 4. That is, the communication network according to another embodiment of the present disclosure may be the IoT based communication network. Also, a communication node performing an operation method according to another embodiment of the present disclosure may be a base station included in the communication network. Also, the base station performing the operation method according to another embodiment of the present disclosure may have a structure similar to or the same as that of the communication node described with reference to FIG. 2.

First, a base station included in the communication network may generate a resource pool for uplink transmission of terminals included in the communication network and a transmission indicator pool corresponding to the resource pool (S510). For example, the resource pool may include time-frequency resources, which are uplink resources available for uplink transmission of the terminals. Also, the transmission indicator pool may include time-frequency resources, which are uplink resources available for transmission of transmission indicators indicating that the uplink transmission of the corresponding terminal is to be performed.

Then, the base station may transmit a message including information on the resource pool and information on the transmission indicator pool to the terminal (S520). Specifically, the base station may generate a message including the information on the resource pool and the information on the transmission indicator pool, and transmit the message to the terminal. For example, the message including the information on the resource pool and the information on the transmission indicator pool may be transmitted through the RRC signaling.

Then, the base station may receive a message including a transmission indicator indicating an uplink transmission from the terminal (S530). Specifically, the message including the transmission indicator received from the terminal may be received through a transmission indicator resource included in the transmission indicator pool described in the steps S410 and S520. Then, the base station may obtain the transmission indicator from the message, and may determine that the uplink transmission will be performed from the corresponding terminal based on the obtained transmission indicator.

Then, the base station may support the uplink transmission of the terminal based on a resource included in the resource pool and a plurality of parameters previously configured for uplink transmission (S540). Here, the plurality of parameters may be parameters for uplink transmission of the terminal, and may be preconfigured by the base station. For example, the plurality of parameters may include an uplink transmission timing, an uplink transmission power, a payload size, and a MCS.

Here, the plurality of parameters are described as being configured in advance by the base station, but embodiments of the present disclosure are not limited thereto. That is, at least one of the plurality of parameters may be configured by the terminal. The at least one parameter configurable by the terminal among the plurality of parameters may be at least one of the uplink transmission timing, the uplink transmission power, and the payload size.

A concrete method of supporting the uplink transmission of the terminal based on a resource included in the resource pool and the plurality of parameters previously configured for uplink transmission at the base station will be described in detail with reference to FIG. 6.

FIG. 6 is a flow chart illustrating a method of supporting uplink transmission of a terminal in a communication network according to another embodiment of the present disclosure.

Referring to FIG. 6, in the communication network according to another embodiment of the present disclosure, the base station may identify a resource indicated by the transmission indicator in the resource pool including uplink resources for uplink transmission in order to support the uplink transmission of the terminal (S541). That is, an uplink resource previously mapped with the transmission indicator may be identified among the uplink resources included in the resource pool.

Thereafter, the base station may receive a message including data from the terminal through the identified uplink resource and based on the plurality of parameters (S542). Specifically, the base station may receive the message including data transmitted from the terminal using a time-frequency resource, which is the identified uplink resource. In addition, the message including data received from the terminal may be received based on the plurality of parameters. For example, the message received based on the uplink transmission timing, the uplink transmission power, the payload size, and the MCS included in the plurality of parameters.

Referring again to FIG. 5, the base station may support the uplink transmission of the terminal based on the uplink resource and the plurality of parameters, as described with reference to FIG. 6. In the communication network according to another embodiment of the present disclosure, the base station may periodically perform the operation method for uplink transmission with a predetermined periodicity. Also, the base station may perform the operation method for uplink transmission non-periodically when the uplink transmission needs to occur in the terminal. That is, the operation method according to another embodiment of the present disclosure may be performed periodically or non-periodically.

Meanwhile, the terminal performing the operation method according to an embodiment or another embodiment of the present disclosure may contend with at least one terminal, or experience a collision in which the terminal selects the same transmission indicator together with at least one terminal, in the procedure of selecting the transmission indicator indicating the uplink transmission of the terminal. Also, the base station performing the operation method according to an embodiment or another embodiment of the present disclosure may be required to distinguish the transmission indicators used in the respective plurality of terminals included in the communication network.

For this, the base station performing the operation method of an embodiment or another embodiment of the present disclosure may preconfigure a signature for identifying each of the plurality of terminals. Accordingly, the terminal performing the operation method of an embodiment or another embodiment of the present disclosure may transmit the message including the transmission indicator based on the signature configured by the base station. For example, the signature used to identify each of the plurality of terminals may refer to a sequence preconfigured by the base station.

In addition, according to the operation method of the communication node for uplink transmission in the communication network according to the embodiment of the present disclosure described with reference to FIGS. 3 to 6, the terminal was described as transmitting the message including data to the base station after transmitting the transmission indicator indicating that the uplink transmission of the terminal is to be performed. In this case, the terminal may transmit the transmission indicator to the base station, and then transmit the message including data to the base station based on a grant received from the base station.

For example, in the communication network, the terminal may transmit the message including the transmission indicator to the base station (a ‘first step’, e.g., a concept similar to a scheduling request). Then, the base station may receive the message including the transmission indicator from the terminal, and transmit an uplink grant for uplink transmission of the terminal to the terminal (a ‘second step’). The terminal may then receive the uplink grant for uplink transmission from the base station, and perform the uplink transmission based on the received uplink grant (a ‘third step’). Through such the method, the terminal and the base station may perform and support the uplink transmission based on the first to third steps in the communication network.

Alternatively, in the communication network, the terminal may transmit the message including the transmission indicator to the base station (a ‘first step’). Then, the base station may receive the message including the transmission indicator from the terminal, and transmit a first uplink grant for uplink transmission of the terminal to the terminal (a ‘second step’). Thereafter, the terminal may receive the first uplink grant from the base station, and transmit a message including state information of the terminal (e.g., channel state, remaining power, buffer state report (BSR), etc.) to the base station based on the received first uplink grant (a ‘third step’). Thereafter, the base station may receive the message including the state information of the terminal, and may transmit a second uplink grant generated based on the state information to the terminal (a ‘fourth step’). Then, the terminal may receive the second uplink grant from the base station, and perform uplink transmission based on the received second uplink grant. Through such the method, the terminal and the base station may perform and support the uplink transmission in the communication network.

FIG. 7 is a flow chart illustrating an operation method of a communication node for uplink transmission in a communication network according to yet another embodiment of the present disclosure.

Referring to FIG. 7, a communication network according to yet another embodiment of the present disclosure may be the same as the communication network described with reference to FIGS. 3 and 6. That is, the communication network according to yet another embodiment of the present disclosure may be the IoT based communication network. Also, a communication node performing an operation method according to yet another embodiment of the present disclosure may be a base station included in the communication network. Also, the base station performing the operation method according to yet another embodiment of the present disclosure may have a structure similar to or the same as that of the communication node described with reference to FIG. 2.

First, in the communication network, the terminal may receive downlink control information (DCI) transmitted from the base station included in the communication network (S710). Specifically, the base station may generate the DCI for uplink transmission. Here, the base station may generate the DCI based on an identifier of a terminal group including at least one terminal at which the uplink transmission is performed. For example, the identifier of the terminal group may refer to a radio network temporary identifier (RNTI) of the terminal group, and may be preconfigured by the base station. Then, the base station may transmit a message including the DCI generated for the uplink transmission of the terminal. Accordingly, the terminal may receive the DCI transmitted from the base station.

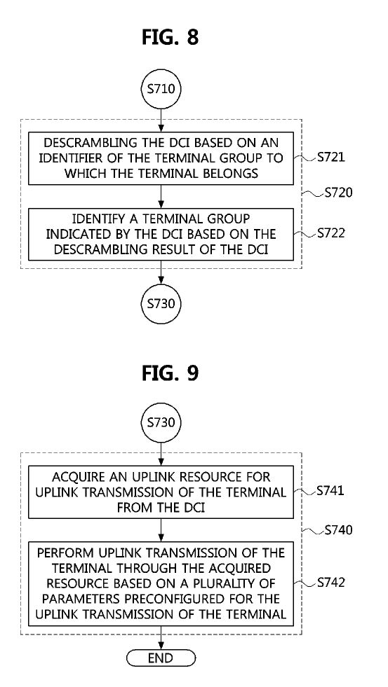

Then, the terminal may identify the terminal group indicated by the DCI based on scrambling of the DCI (S720). A concrete method of identifying the terminal group indicated by the DCI based on scrambling for the DCI at the terminal will be described with reference to FIG. 8.

FIG. 8 is a flow chart illustrating a method of identifying a terminal group in a communication network according to yet another embodiment of the present disclosure.

Referring to FIG. 8, in the communication network according to yet another embodiment of the present disclosure, the terminal may descramble the DCI based on the identifier of the terminal group to which the terminal belongs (S721). Specifically, the terminal may detect the DCI through blind detection on a channel (e.g., a PDCCH) through which the DCI is transmitted, and descramble cyclic redundancy check (CRC) bits included in the detected DCI based on the identifier of the terminal group.

Then, the terminal may identify the terminal group indicated by the DCI based on the result of the descrambling (S722). That is, the terminal may identify the terminal group including at least one terminal set as the destination of the DCI in the base station.

Referring again to FIG. 7, the terminal may confirm whether the identified terminal group is the same as the terminal group to which the terminal belongs (S730). That is, the terminal may determine, based on the descrambling result, whether the DCI received from the base station is the DCI corresponding to the terminal group in which the terminal included.

Then, when the identified terminal group is the terminal group to which the terminal belongs, the terminal may perform the uplink transmission of the terminal (S740). A concrete method of performing uplink transmission on the basis of the DCI at the terminal may be the same as that of the embodiments of the present disclosure described with reference to FIGS. 3 to 6. Also, a concrete method for performing uplink transmission on the basis of the DCI at the terminal will be described with reference to FIG. 9.

FIG. 9 is a flow chart illustrating a method for performing uplink transmission of a terminal in a communication network according to yet another embodiment of the present disclosure.

Referring to FIG. 9, in the communication network according to yet another embodiment of the present disclosure, the terminal may acquire uplink resources for uplink transmission of the terminal from the DCI (S741). For example, the uplink resource may mean a time-frequency resource available for the uplink transmission of the terminal.

Then, the terminal may perform the uplink transmission through the acquired uplink resource based on a plurality of parameters previously configured for the uplink transmission of the terminal (S742). Here, the plurality of parameters may be different from the plurality of parameters described with reference to FIGS. 3 to 6. For example, the plurality of parameters may include a signature, a power, and a transport block (TB) size used for the uplink transmission of the terminal. Such the plurality of parameters may be preconfigured by the base station.

Referring again to FIG. 7, when the terminal group identified in the step S730 is not the terminal group to which the terminal belongs, the terminal may perform monitoring on DCIs received periodically or aperiodically after the step S710. That is, when a DCI corresponding to the terminal group to which the terminal belongs is detected by monitoring DCIs periodically or aperiodically received from the base station, the terminal may perform the step S740 of the uplink transmission of the terminal.

As described above, according to the operation method according to yet another embodiment of the present disclosure, in the communication network, the terminal may perform the uplink transmission based on the DCI received from the base station. For example, in the communication network, the base station may allocate uplink resources for the uplink transmission of the terminal based on the DCI. Here, the base station may allocate the uplink resources for the uplink transmission of the terminal in a semi-persistent scheduling (SPS) scheme.

Specifically, the base station may allocate the uplink resources for the uplink transmission of the terminal to the terminal in the SPS scheme through the DCI. Then, the terminal may transmit a message including data and a BSR to the base station by using the uplink resource allocated based on the SPS scheme by the base station. Thereafter, the base station may receive the message including the data and the BSR from the terminal. Then, the base station may transmit an ACK message or a NACK message to the terminal based on whether the message including the data and the BSR is successfully received.

When the terminal receives a NACK message from the base station in response to the message including the data and the BSR, the terminal may retransmit the message including the data and the BSR through the uplink resource allocated by the base station in the SPS scheme. On the other hand, when an ACK message is received from the base station in response to the message including the data and the BSR, the terminal may check whether data exists in a buffer.

Thereafter, when there is data in the buffer, the terminal may transmit a message including the data existing in the buffer to the base station by using the uplink resource allocated based on the SPS scheme by the base station. Here, when there is no data in the buffer, the terminal may stop the uplink transmission.

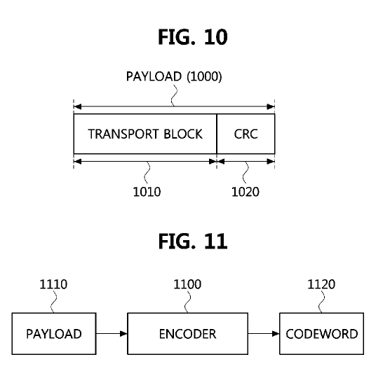

Hereinafter, a method of configuring a payload size for uplink transmission and a channel coding method in a communication network according to the present disclosure described with reference to FIGS. 3 to 9 will be described in detail with reference to FIGS. 10 to 13.

FIG. 10 is a conceptual diagram illustrating a first embodiment of a payload of a communication network according to an embodiment of the present disclosure, and FIG. 11 is a conceptual diagram illustrating a first embodiment of a channel coding process in a communication network according to an embodiment of the present disclosure.

Referring to FIG. 10, a terminal performing the operation method according to an embodiment of the present disclosure may configure the size of a payload 1000 by itself, which is one of the plurality of parameters for uplink transmission. In particular, the payload 1000 may include a transport block 1010 and a CRC 1020 (or, ‘CRC bits’). For example, the payload 1000 may vary depending on the size of the transport block 1010, assuming that the size of the CRC 1020 is constant regardless of the transport block 1010.

In the communication network, the terminal may perform encoding and modulation on the payload 1000. Then, the terminal may generate a message including the encoded and modulated payload, and transmit the message including the encoded and modulated payload to the base station. Accordingly, the base station may receive the message including the encoded and modulated payload from the terminal, and may perform demodulation and decoding on the encoded and modulated payload.

Referring to FIG. 11, in the communication network, the terminal may perform encoding on the payload 1110 by inputting the payload 1110 to an encoder 1100. Accordingly, the terminal may acquire a codeword 1120 which indicates the encoded payload.

Referring again to FIG. 10, the terminal may transmit the payload 1000 to the base station. Here, the terminal may set the size of the transport block 1010 included in the payload 1000 in order to set the size of the payload 1000. For example, the terminal may select a transport block size among a plurality of transport block sizes that can be selected to the size of the transport block 1010 included in the payload 1000.

The terminal may then generate the transport block 1010 based on the set transport block size and perform encoding and modulation on the payload 1000 including the generated transport block 1010 and the CRC 1020. Then, the terminal may transmit a message including the encoded and modulated payload to the base station.

Accordingly, the base station may receive the message including the encoded and modulated payload from the terminal, and may perform demodulation and decoding on the encoded and modulated payload. Here, the base station may perform decoding on the encoded and modulated payload based on the plurality of transport block sizes available in the terminal. The base station may then determine the CRC of the decoded payload based on the plurality of transport block sizes.

Thereafter, the base station may determine that the reception of the corresponding payload is successful if the CRC check result is successful. In this case, the base station may generate an ACK message indicating that the payload has been successfully received, and transmit the generated ACK message to the terminal. On the other hand, if the CRC check result indicates that there is no successful transport block size, the base station may determine that the corresponding payload has failed to be received. In this case, the base station may generate a NACK message indicating that the payload has failed to be received, and transmit the generated NACK message to the terminal.

Meanwhile, although it has been described that the base station of the communication network decodes the payload based on the plurality of transport block sizes available in the terminal, this may be appropriate when the size of the transport block included in the payload of the terminal is set to the largest transport block size (e.g., TBS_max) among the plurality of available transport block sizes.

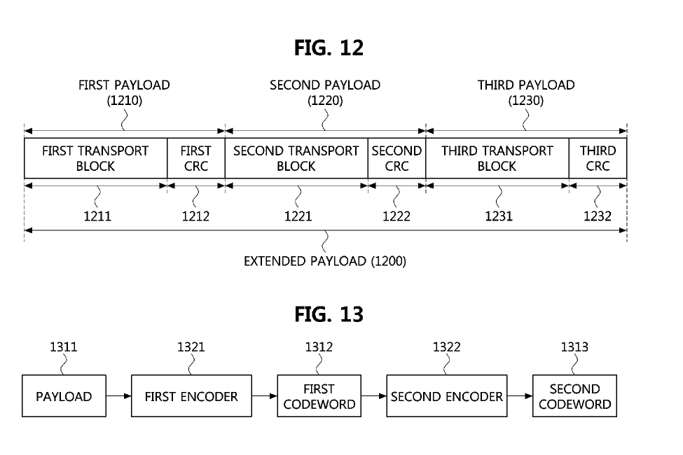

In addition, in the communication network, the terminal may set the size of the transport block included in the payload to a size smaller than the largest maximum transport block size (TBS_max) among the plurality of available transport block sizes. The case of setting the transport block size smaller than the maximum transport block size in the terminal will be described in detail with reference to FIG. 12.

FIG. 12 is a conceptual diagram illustrating a second embodiment of a payload of a communication network according to an embodiment of the present disclosure, and FIG. 13 is a conceptual diagram illustrating a second embodiment of a channel coding process in a communication network according to an embodiment of the present disclosure.

Referring to FIG. 12, in the communication network, the terminal may set a size of a transport block included in a payload to be transmitted. Then, the terminal may generate the payload (referred to as ‘selected size payload’ for convenience of explanation) including the transport block having the configured size and a CRC.

Then, if the size of the selected size payload is smaller than the maximum transport block size, the terminal may convert the selected size payload into a payload (referred to as ‘a maximum size payload’ or ‘an extended payload’ for convenience of explanation) of a size corresponding to a transport block having the maximum transport block size and a CRC. Then, the terminal may transmit a message including the converted the maximum size payload to the base station.

For example, the terminal may generate a first transport block 1211 whose size is smaller than the maximum transport block size. The terminal may then generate a first payload 1210 including the first transport block 1211 and a first CRC 1212. Here, the first payload may be the same size and the same bit values as the selected size payload. The terminal may then generate a second transport block 1221 having the same size and the same bit values as the first transport block 1211 and a second CRC 1222 having the same size and the same bit values as the first CRC 1212, and configure a second payload 1220 including the second transport block 1221 and the second CRC 1222. That is, the sizes of the first payload 1210 and the second payload 1220 may be the same. Then, the terminal may then generate a third transport block 1231 having the same size and the same bit values as the first transport block 1211 and a third CRC 1232 having the same size and the same bit values as the first CRC 1212, and configure a third payload 1230 including the third transport block 1231 and the third CRC 1232. That is, the sizes of the first payload 1210, the second payload 1220, and the third payload 1230 may be the same.

Through the above-described manner, the terminal may generate the first payload 1210, the second payload 1220, and the third payload 1230 using the selected size payload, and generated an extended payload 1200 by concatenating the respective payloads. That is, the size of the extended payload 1200 generated by the terminal may be equal to the size of the payload including the CRC and the transport block having the maximum transport block size configurable by the terminal.

Thereafter, the terminal may perform encoding and modulation of the extended payload 1200 and then generate a message including the extended payload 1200. The terminal may then transmit a message including the extended payload 1200 to the base station. Since the base station does not know the selected size payload of the terminal in advance, the base station may perform decoding on all sizes of the selected size payload that the terminal can select.

In this case, it may be assumed that the terminal transmits a message including the extended payload 1200 having the same size as the maximum size payload. Then, the base station may acquire the selected size payload through the following process from the message received from the terminal. The base station may perform the demodulation and decoding and check the CRC under the assumption that the size of the transport block transmitted by the terminal corresponds to the maximum size payload.

Then, when the result of checking the CRC is not successful, the base station may assume that the payload transmitted by the terminal has a repetitive pattern of the extended payload 1200 obtained by extending the selected size payload, and perform decoding on the selected size payload based on the repetitive pattern. Since log-likelihood atio (LLR) values obtained by performing the demodulation and decoding under the assumption that the transport block is the maximum size payload correspond to LLR values of the bits included in the repetitive pattern of the extended payload 1200, the base station may obtain LLR values for respective bits of the selected size payload based on respective sums of LLR values of the respective bits included in the repetitive pattern. Through this, the CRC included in the selected size payload may be identified. Then, if the result of checking the CRC is successful, the base station may determine that the selected size payload transmitted by the terminal has the same size as the first payload 1210, generate an ACK message indicating that the reception is successful, and transmit the ACK message to the terminal.

As described above, the payload transmitted through the uplink transmission in the communication network according to an embodiment of the present disclosure may be generated based on repetition coding so as to have the length of the maximum size payload. Meanwhile, in the communication network according to an embodiment of the present disclosure, the payload transmitted through the uplink transmission may be generated based on channel coding (e.g., serial composite channel coding) so as to have the length of the maximum size payload, which will be specifically described below with reference to FIG. 13.

Referring to FIG. 13, in the communication network, the terminal may configure a size of a transport block included in the payload transmitted through the uplink transmission. The terminal may then generate the payload 1231, which is a selected size payload including the transport block having the configured size and a CRC. Then, the terminal may convert the payload 1311 by using a first encoder 1321 so that the size of the payload 1311 becomes the size of the maximum size payload (or, ‘extended payload’) including the transport block having the maximum transport block size and the CRC, thereby obtaining a first codeword 1212 whose size has been converted to the size of the maximum size payload. Thereafter, the terminal may perform encoding and modulation on the first codeword 1212 by using a second encoder 1322, thereby obtaining a second codeword 1313. Then, the terminal may generate a message including the second codeword 1313 and transmit the message including the second codeword 1313 to the base station.

Accordingly, the base station may receive the message including the second codeword 1313 from the terminal. Then, the base station may perform demodulation and decoding under the assumption that the size of the transport block transmitted by the terminal corresponds to the maximum size payload, and check the CRC. Thereafter, if the result of checking the CRC is not successful, the base station may further perform decoding of the first codeword 1312 and check the CRC. More specifically, the base station may use LLR values of the bits of the first codeword 1312 obtained by performing the demodulation and decoding under the assumption that the size of the transport block corresponds to the maximum size payload as inputs to the decoder to further perform the decoding of the first codeword 1312, and generate LLR values for the bits of the transport block corresponding to the information block in the payload transmitted by the terminal and the CRC bits.

Thereafter, if the result of checking the CRC is successful, the base station may generate an ACK message indicating that the payload 1311 has been successfully received, and transmit the generated ACK message to the terminal. On the other hand, if the result of checking the CRC is not successful, the base station may generate a NACK message indicating that the reception of the extended payload 1311 has failed, and transmit the generated NACK message to the terminal.

Meanwhile, in the communication network according to an embodiment of the present disclosure, the base station may perform decoding on data (i.e., payload) received from the terminal, and generate a message including response information on receipt of the data. The response information generated at the base station may include terminal confirmation information and information on whether the reception of the data is successful or not. Here, the terminal confirmation information may indicate a resource mapped to a signature of a specific terminal.

For example, when a first terminal transmits a message including data based on a first signature, the base station may transmit response information for it based on a resource mapped to the first signature. Accordingly, the first terminal may perform energy detection based on the resource mapped to the first signature.

The first terminal may then determine that the terminal confirmation information has been received successfully if an energy having an intensity greater than or equal to a preset threshold value is detected in the resource mapped to the first signature. In addition, when the first terminal receives the terminal confirmation information and the indicator indicating a successful reception, the first terminal may determine that the message including the data of the first terminal has been successfully received. On the other hand, when the first terminal receives the indicator indicating a reception failure together with the terminal confirmation information from the base station, the first terminal may determine that the reception of the message including the data of the first terminal has failed and retransmit the message including the data of the first terminal.

Also, the first terminal may determine that the terminal confirmation information has not been successfully received if an energy having an intensity greater than or equal to a preset threshold value is not detected in the resource mapped to the first signature. In this case, the first terminal may perform retransmission of the message including the response information based on the resource mapped to the first signature.

Meanwhile, when the autonomous transmission (e.g., non-orthogonal uplink transmission) is supported in the communication network, the terminal may transmit uplink data to the base station without an uplink grant. For example, the terminal may select a resource in the preconfigured resource pool and transmit the uplink data to the base station by using the selected resource. Here, the preconfigured resource pool may be shared by the base station and a plurality of terminals. Since the terminal may not know resources used by other terminals, the resource selected by the terminal in the preconfigured resource pool may be overlapped with the resources used by the other terminals. In this case, a plurality of terminals may transmit uplink data using the same resource, thereby causing a transmission collision.

The resource pool may include a plurality of orthogonal resources. When a plurality of terminals perform communications using the orthogonal resources, interference may not occur due to orthogonality between the resources. For example, in the OFDMA-based communication network, each of subcarriers may be an orthogonal resource that does not cause interference. Alternatively, the resource pool may include a plurality of non-orthogonal resources. When a plurality of terminals perform communications using the non-orthogonal resources, interference may occur due to non-orthogonality between the resources. For example, in the CDMA-based communication network, a plurality of terminals may perform communications using the same time-frequency resources, in which case the same time-frequency resources may be non-orthogonal resources.

Meanwhile, in the communication network supporting the autonomous transmission (e.g., non-orthogonal uplink transmission), the terminal may perform communications using a resource selected from the resource pool. The maximum number of orthogonal resources generated based on the resources belonging to the resource pool may be determined according to the size of resources belonging to the resource pool, and the maximum number of non-orthogonal resources generated based on the resources belonging to the resource pool may be greater than the maximum number of the orthogonal resources. In this case, comparing a case of selecting an arbitrary orthogonal resource among the orthogonal resources in the resource pool (hereinafter referred to as an ‘orthogonal resource selection scheme’) with a case of selecting an arbitrary non-orthogonal resource among the non-orthogonal resources in the resource pool (hereinafter referred to as a ‘non-orthogonal resource selection scheme’), a probability that a plurality of terminals select the same resource may be higher in the orthogonal resource selection scheme than in the non-orthogonal resource selection scheme.

In the case of a resource collision in which a plurality of terminals select the same resource in the resource pool, it may be difficult for the base station to distinguish signals of the plurality of terminals received through the same resource, and it may also be difficult to estimate a radio channel of each of the plurality of terminals. In this case, a probability that the uplink data of each of the plurality of terminals is successfully decoded at the base station may be low. Therefore, when the resource collision occurs, the performance of the communication network may deteriorate, and thus it is desirable to prevent the resource collision as much as possible.

Also, it may be advantageous to use the non-orthogonal resource selection scheme rather than the orthogonal resource selection scheme in terms of frequency utilization efficiency of the communication network. When the non-orthogonal resource selection scheme is used, the base station may operate with a higher performance than the orthogonal resource selection scheme by cancelling mutual interferences between the terminals. In an environment where the mutual interferences exist between terminals, the terminal may transmit an uplink signal using a channel coding scheme having a low coding rate so that the base station can easily decode the uplink signal of the terminal. The base station may decode uplink signals of other terminals by removing the decoded uplink signal of the terminal from the entire uplink signals.

However, when the terminal performs uplink transmission using a non-orthogonal resource selected from the resource pool, the base station is required to perform blind detection on non-orthogonal resources that the terminal may select. Also, the greater the number of non-orthogonal resources the terminal may select, the more the base station is required to perform the blind detection. Therefore, the complexity of the base station (e.g., a receiver included in the base station) may be increased.

Next, embodiments (e.g., a spreading scheme based uplink transmission and reception methods and apparatuses) for improving reception performance and reducing reception complexity in the communication network supporting the autonomous transmission (e.g., non-orthogonal uplink transmission) will be described. In the embodiments described below, the preconfigured resource pool may include at least one of orthogonal resources and non-orthogonal resources, and the preconfigured resource pool may be shared by the base station and the terminal, and communications between the base station and the terminal may be performed using the preconfigured resource pool. The terminal may be in a state of acquiring the uplink synchronization with the base station or may be in a state of not acquiring the uplink synchronization with the base station. The terminal that has not acquired the uplink synchronization may perform an uplink synchronization acquisition procedure to perform communications based on the preconfigured resource pool. The resources used for uplink communications (e.g., orthogonal resources or non-orthogonal resources in the preconfigured resource pool) may be allocated by the base station or selected by the terminal.

Also, in the embodiments described below, when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of the terminal is described, the corresponding base station may perform an operation corresponding to the operation of the terminal. Conversely, when an operation of the base station is described, the corresponding terminal may perform an operation corresponding to the operation of the base station.

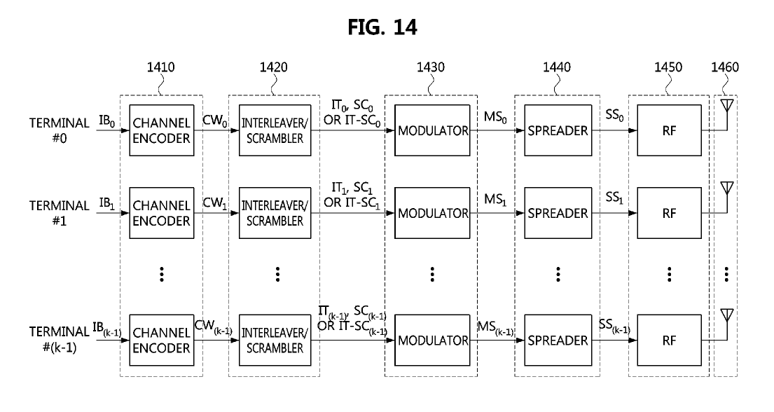

FIG. 14 is a block diagram illustrating a first embodiment of a terminal constituting a communication network.

Referring to FIG. 14, a terminal (e.g., each of terminals #0 to #(k−1)) may comprise a channel encoder 1410, an interleaver/scrambler 1420, a modulator 1430, a spreader 1440, a radio frequency (RF) unit 1450, an antenna 1460, and the like. Here, k may be a positive integer of 1 or more. The operation of each of the channel encoder 1410, the interleaver/scrambler 1420, the modulator 1430, the spreader 1440, the RF unit 1450, and the antenna 1410 may be performed by the processor 210 shown in FIG. 2.

In the non-orthogonal uplink transmission procedure, information blocks IB₀, IB₁, . . . , and IB₍ₖ₋₁₎ may be input to the channel encoder 1410. The channel encoder 1410 may output codewords CW₀, CW₁, . . . , and CW₍ₖ₋₁₎ by performing coding operations on the information blocks IB₀, IB₁, . . . , and IB₍ₖ₋₁₎. The codewords CW₀, CW₁, . . . , and CW₍ₖ₋₁₎ may be input to the interleaver/scrambler 1420. The interleaver/scrambler 1420 may output interleaved signals IT₀, IT₁, . . . , and IT₍ₖ₋₁₎ by performing interleaving operations on the codewords CW₀, CW₁, . . . , and CW₍ₖ₋₁₎. Alternatively, the interleaver/scrambler 1420 may output scrambled signals SC₀, SC₁, . . . , SC₍ₖ₋₁₎ by performing scrambling operations on the codewords CW₀, CW₁, . . . , and CW₍ₖ₋₁₎. Alternatively, the interleaver/scrambler 1420 may output interleaved and scrambled signals IT-SC₀, IT-SC₁, . . . , and IT-SC₍ₖ₋₁₎ by performing the interleaving and scrambling operations on the codewords CW₀, CW₁, . . . , and CW₍ₖ₋₁).

The signals generated by interleaver/scrambler 1420 may be input to the modulator 1430. The modulator 1430 may output modulated symbols MS₀, MS₁, . . . , and MS₍ₖ₋₁₎ by performing modulation operations on the input signals. The modulation operation may be performed based on a quadrature phase shift keying (QPSK) scheme, a 16 quadrature amplitude modulation (16QAM) scheme, a 64QAM, or the like. In this case, since the bits belonging to the same modulated symbol (e.g., MS₀, MS₁, . . . , and MS₍ₖ₋₁₎ experience the same channel, a bit-level interleaving may be applied so that the bits belonging to the same modulated symbol (e.g., MS₀, MS₁, . . . , and MS₍ₖ₋₁₎ are spaced apart from each other.

The modulated symbols MS₀, MS₁, . . . , and MS₍ₖ₋₁₎ may be input to the spreader 1440. The spreader 1440 may output spread symbols SS₀, SS₁, . . . , and SS₍ₖ₋₁₎ by performing spreading operations on the demodulated symbols MS₀, MS₁, . . . , and MS₍ₖ₋₁₎. Then, resource mapping operations for the spread symbols SS₀, SS₁, . . . , and SS₍ₖ₋₁₎ may be performed and the spread symbols SS₀, SS₁, . . . , and SS₍ₖ₋₁₎ may be transmitted to the base station through the RF unit 1450 and the antenna 1460.

Meanwhile, the gain of the coding operation performed by the channel encoder 1410 and the gain of the spreading operation performed by the spreader 1440 in the non-orthogonal uplink transmission procedure may be as follows.

Coding Gain and Spreading Gain

When a mother code rate of the channel encoder 1410 is R, the length of the information blocks IB₀, IB₁, . . . , and IB₍ₖ₋₁₎ input to the channel encoder 1410 is L bits, and the length of the codewords CW₀, CW₁, . . . , and CW₍ₖ₋₁₎ output from the channel encoder 1410 is N, the following Equation 1 may be defined.

$$N = \frac{L}{R} \qquad [ Equation 1 ]$$

Here, the codeword satisfying Equation 1 may be referred to as a ‘full codeword’, and the codeword having a length smaller than N may be referred to as a ‘partial codeword’.

Coding gain and spreading gain in the non-orthogonal uplink transmission procedure of a single terminal

When a specific channel is used by one terminal, a full codeword may be transmitted to obtain optimal communication performance. When the length of the information blocks IB₀, IB₁, . . . , and IB₍ₖ₋₁₎ input to the channel encoder 1410 is L bits and a mode code rate for the specific channel is R, the length of the full code work may be determined according to Equation 1.

When the size of the time-frequency resources (hereinafter referred to as ‘entire uplink time-frequency resources’) allocated for the non-orthogonal uplink transmission is N or more, the terminal may repeatedly transmit the full codeword using the remaining uplink time-frequency resources excluding the uplink time-frequency resources used for transmission of the full codeword among the entire uplink time-frequency resources (hereinafter, referred to as a ‘repetitive transmission scheme’). That is, the full codeword may be additionally transmitted using the remaining uplink time-frequency resources.

Alternatively, when the size of the entire uplink time-frequency resources is greater than or equal to N, the terminal may transmit a full codeword (e.g., a spread symbol) to which the spreading operation is applied through the remaining uplink time-frequency resources (hereinafter, referred to as a ‘spreading transmission scheme’). There may not be a difference in performance between the repetitive transmission scheme and the spreading transmission scheme in an additive white Gaussian noise (AWGN) channel. However, a performance in the case where the partial code word is transmitted based on the repetitive transmission scheme or the spreading transmission scheme through the remaining time-frequency resources among the entire uplink time-frequency resources may be lower than a performance in the case where the full code word is transmitted based on the repetitive transmission scheme or the spreading transmission scheme through the remaining time-frequency resources among the entire uplink time-frequency resources.

Coding Gain and Spreading Gain in the Non-Orthogonal Uplink Transmission Procedure of a Plurality of Terminals

When a plurality of terminals perform the non-orthogonal uplink transmission using the same time-frequency resources, an orthogonal spreading scheme or a non-orthogonal spreading scheme may be used. In the orthogonal spreading scheme, a plurality of terminals may perform spreading operations using orthogonal spreading sequences. When the orthogonal spreading scheme is used in an ideal channel environment, interferences between the plurality of terminals may not exist. For example, interferences between the plurality of terminals may be canceled by the orthogonal spreading sequences, and the effects of residual noises and interferences may be overcome through the coding gain.

In the spreading operation performed by the spreader 1450, a relatively small spreading factor (e.g., the length of the spreading sequence) may be used when the length of the codeword is long, and a relatively large spreading factor may be used when the length of the codeword is short. In order to increase the coding gain, the codeword should be long and the spreading factor should be large in order to efficiently cancel the interferences between as many terminals as possible. Therefore, there may be a trade-off relationship between the code rate and the spreading factor. Accordingly, the code rate and the spreading factor may be selected in consideration of the number of terminals using the same time-frequency resources, transmission and reception power of each of the terminals, interference condition between terminals, noise, coding gain, and the like.

Meanwhile, in the non-orthogonal uplink transmission procedure, when a plurality of terminals use the same time-frequency resources and the non-orthogonal spreading scheme, optimal performance can be obtained by transmission of the full codeword. Considering the interferences between the plurality of terminals, the effect of the spreading transmission scheme (e.g., non-orthogonal spreading transmission scheme) may be the same as the effect of the repetitive transmission scheme. Therefore, when the full codeword is used to maximize the coding gain and the non-orthogonal spreading transmission method or the repetitive transmission scheme is used, optimal performance can be obtained.

Non-Orthogonal Uplink Transmission Procedure ased on the Orthogonal and Non-Orthogonal Spreading Scheme

In the non-orthogonal uplink transmission procedure, an orthogonal and non-orthogonal spreading scheme may be used to improve communication performance. For example, an orthogonal spreading scheme may be used within a range in which the coherence of the channel in the time and frequency axes is guaranteed. Also, the orthogonal spreading scheme may be used first, and the non-orthogonal spreading scheme may be additionally used to enhance overloading. Also, the orthogonal and non-orthogonal spreading scheme may be used to maximize the coding gain.

If the codeword is lengthened to improve the coding gain, the length of the spreading sequence becomes relatively short, so that the number of orthogonal terminals may be reduced when the orthogonal spreading scheme is performed. On the other hand, if the length of the spreading sequence is set to be relatively long in order to increase the number of orthogonal terminals, the coding gain may be reduced. Therefore, the length of the spreading sequence may be set considering the channel environment, coherence in the time axis, coherence in the frequency axis, and the like.

The spreading sequences may be grouped. For example, spreading sequences belonging to the same spreading group may be set to be orthogonal, and spreading sequences belonging to different spreading groups may be set to be non-orthogonal. For example, spreading groups each of which includes at least one spreading sequence may be configured as shown in Table 1 below.

TABLE 1

| | The number of spreading sequences |
|---|---|
| Spreading group #0 | N_{ortho #0} |
| Spreading group #1 | N_{ortho #1} |
| . . . | . . . |
| Spreading group #(g-1) | N_{ortho #(g-1)} |

Here, g spreading groups may exist, and each of the spreading groups may include Nₒᵣₜₕₒ orthogonal spreading sequences. Also, g non-orthogonal spreading sequences may exist. Here, g may be a positive integer of 1 or more. When Nₒᵣₜₕₒ=1 and g>1, since only the non-orthogonal spreading sequences are used, the terminals may perform the uplink transmission based on the NOMA scheme. On the other hand, when Nₒᵣₜₕₒ>1 and g=1, since only the orthogonal spreading sequences are used, the terminals may perform the uplink transmission based on an orthogonal multiple access (OMA) scheme.

For example, the terminal may perform an orthogonal spreading operation using one orthogonal spreading sequence among the Nₒᵣₜₕₒ orthogonal spreading sequences. The spread symbols SS₀, SS₁, . . . , and SS₍ₖ₋₁₎ may be generated by the orthogonal spreading operation and the spread symbols SS₀, SS₁, . . . , and SS₍ₖ₋₁₎ may be mapped in a time-frequency resource having channel coherence characteristics. Alternatively, the terminal may perform a non-orthogonal spreading operation using one non-orthogonal spreading sequence among the g non-orthogonal spreading sequences. The spread symbols SS₀, SS₁, . . . , and SS₍ₖ₋₁₎ may be generated by the non-orthogonal spreading operation and the spread symbols SS₀, SS₁, . . . , and SS₍ₖ₋₁₎ may be mapped to be spaced apart from each other in a time-frequency resource. Here, the base station may transmit to the terminal a signaling message, system information, or downlink control information (DCI) including information indicating a spreading sequence to be used by the terminal.

Alternatively, spreading groups each of which includes at least one spreading sequence may be configured as shown in Table 2 below.

TABLE 2

| | The number of spreading sequences |
|---|---|
| Orthogonal spreading | Nₒᵣₜₕₒ |
| group | |
| Non-orthogonal | Nₙₒₙ₋ₒᵣₜₕₒ |
| spreading group | |

The spreading groups may be classified into an orthogonal spreading group and a non-orthogonal spreading group, and the orthogonal spreading group may include at least one orthogonal spreading sequence, and the non-orthogonal spreading group may include at least one non-orthogonal spreading sequence. For example, the orthogonal spreading group may include Nₒᵣₜₕₒ orthogonal spreading sequences, and the non-orthogonal spreading group may include Nₙₒₙ₋ₒᵣₜₕₒ non-orthogonal spreading sequences. When Nₒᵣₜₕₒ=0 and Nₙₒₙ₋ₒᵣₜₕₒ>1, since only the non-orthogonal spreading sequences are used, the terminals may perform the uplink transmission based on the NOMA scheme. On the other hand, when Nₒᵣₜₕₒ>1 and Nₙₒₙ₋ₒᵣₜₕₒ=0, since only the orthogonal spreading sequences are used, the terminals may perform the uplink transmission based on the OMA scheme.

For example, the terminal may perform a spreading operation using one spreading sequence among the Nₒᵣₜₕₒ orthogonal spreading sequences and the Nₙₒₙ₋ₒᵣₜₕₒ non-orthogonal spreading sequences. The spread symbols SS₀, SS₁, . . . , and SS_{(k—1)} may be generated by the orthogonal spreading operation and the spread symbols SS₀, SS₁, . . . , and SS₍ₖ₋₁₎ may be mapped in a time-frequency resource having channel coherence characteristics. Alternatively, the spread symbols SS₀, SS₁, . . . , and SS₍ₖ₋₁₎ may be generated by the non-orthogonal spreading operation and the spread symbols SS₀, SS₁, . . . , and SS₍ₖ₋₁₎ may be mapped to be spaced apart from each other in a time-frequency resource.

Meanwhile, the spreader 1440 of the terminal may perform a spreading operation on the modulated symbols using the same spreading sequence. For example, the spread symbols generated by the spreader 1440 may be as follows.

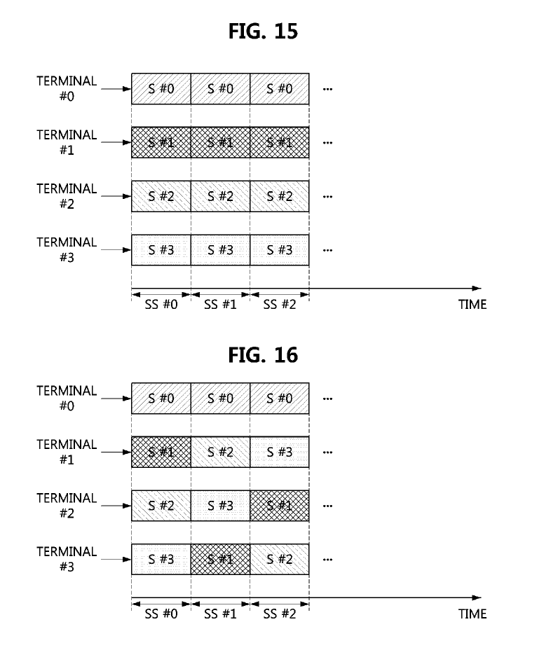

FIG. 15 is a conceptual diagram illustrating a first embodiment of a spreading based non-orthogonal uplink transmission method.

Referring to FIG. 15, a plurality of terminals (terminals #0 to #3) may perform non-orthogonal uplink transmissions using the same time-frequency resources. Here, S #0, S #1, S #2, and S #3 may be orthogonal spreading sequences or non-orthogonal spreading sequences. For example, S #0, S #1, S #2, and S #3 may belong to the spreading group of Table 1 or the spreading group of Table 2. The spreader 1440 of the terminal #0 may perform spreading operations on all modulated symbols (e.g., MS0 to MS2 corresponding to SS0 to SS2) using S #0, and the spreader 1440 of the terminal #1 may perform spreading operations on all modulated symbols using S #1. The spreader 1440 of the terminal #2 may perform spreading operations on all modulated symbols using S #2, and the spreader 1440 of the terminal #3 may perform spreading operations on all modulated symbols using S #3. That is, each of the plurality of terminals (terminals #0 to #3) may perform spreading operations on all modulated symbols using the same spreading sequence.

Sequence Hopping Based Spreading Operation

Meanwhile, the spreader 1440 of the terminal may perform spreading operations on the modulated symbols using different spreading sequences (e.g., spreading sequences according to a predefined hopping pattern). For example, the spread symbols generated by the spreader 1440 may be as follows.

FIG. 16 is a conceptual diagram illustrating a second embodiment of a spreading based non-orthogonal uplink transmission method.

Referring to FIG. 16, a plurality of terminals (terminals #0 to #3) may perform non-orthogonal uplink transmissions using the same time-frequency resources. Here, S #0, S #1, S #2, and S #3 may be orthogonal spreading sequences or non-orthogonal spreading sequences. For example, S #0, S #1, S #2, and S #3 may belong to the spreading group of Table 1 or the spreading group of Table 2. When the number of modulated symbols is N, up to N orthogonal spreading sequences may be used.

The spreader 1440 of the terminal #0 may perform spreading operations on the modulated symbols (e.g., MS #0 to MS #2 corresponding to SS #0 to SS #2) using S #0. When the sequence hopping pattern for the terminal #1 is configured as (S #1→S #2→S #3), the spreader 1440 of the terminal #1 may perform the spreading operation on the first modulated symbol (e.g., MS #0 corresponding to SS #0) using S #1, perform the spreading operation on the second modulated symbol (e.g., MS #1 corresponding to SS #1) using S #2, and perform the spreading operation on the third modulated symbol (e.g., MS #2 corresponding to SS #2) using S #2.

When the sequence hopping pattern for the terminal #2 is configured as (S #2→S #3→S #1), the spreader 1440 of the terminal #2 may perform the spreading operation on the first modulated symbol (e.g., MS #0 corresponding to SS #0) using S #2, perform the spreading operation on the second modulated symbol (e.g., MS #1 corresponding to SS #1) using S #3, and perform the spreading operation on the third modulated symbol (e.g., MS #2 corresponding to SS #2) using S #1.

When the sequence hopping pattern for the terminal #3 is configured as (S #3→S #1→S #2), the spreader 1440 of the terminal #3 may perform the spreading operation on the first modulated symbol (e.g., MS #0 corresponding to SS #0) using S #3, perform the spreading operation on the second modulated symbol (e.g., MS #1 corresponding to SS #1) using S #1, and perform the spreading operation on the third modulated symbol (e.g., MS #2 corresponding to SS #2) using S #2.

In the case that the relationship of the spreading sequences S #0 to S #4 is as shown in Table 3 below, the SS #1 of the terminal #1 may be orthogonal to the SS #0 of the terminal #0, and the SS #0 of the terminal #1 may be non-orthogonal to the SS #0 of the terminals #2 and #3. The SS #1 of the terminal #1 may be orthogonal to the SS #1 of the terminal #2, and the SS #1 of the terminal #1 may be non-orthogonal to the SS #1 of the terminals #0 and #3. The SS #2 of the terminal #1 may be orthogonal to the SS #2 of the terminal #3, and the SS #2 of the terminal #1 may be non-orthogonal to the SS #2 of the terminals #0 and #2.

TABLE 3

| | S #0 | S #1 | S #2 | S #3 |
|---|---|---|---|---|
| S #0 | — | orthogonal | non-orthogonal | non-orthogonal |
| S #1 | orthogonal | — | non-orthogonal | non-orthogonal |
| S #2 | non-orthogonal | non-orthogonal | — | orthogonal |
| S #3 | non-orthogonal | non-orthogonal | orthogonal | — |

Meanwhile, when the spreading sequence having the length of L allocated for a modulated symbol q of a terminal #a (e.g., terminal #0) is S_{q}^{a}(i) (i=0, 1, . . . , L−1) and the spreading sequence having the length L allocated for a modulated symbol q of a terminal #b (e.g., terminal #1) is S_{q}^{b}(i) (i=0, 1, . . . , L−1), the below Equation 2 or 3 may be defined.

Σₙ₌₀^{L-1}S_{q}^{b}(n)·S_{q}^{b}(n)=0 [Equation 2]

Σₙ₌₀^{L-1}S_{q}^{a}(n)·S_{q}^{b}(n)≠0 [Equation 3]

Equation 2 may represent that the spreading sequence of the terminal #a is orthogonal to the spreading sequence of the terminal #b, and Equation 3 may represent that the spreading sequence of the terminal #a is non-orthogonal to the spreading sequence of terminal #b. In the embodiment shown in FIG. 16, some spread symbols may satisfy Equation 2, and the remaining spreading symbols may satisfy Equation 3.

Spreading Sequence Configuration Scheme

In the non-orthogonal uplink transmission procedure based on spreading (e.g., the embodiment shown in FIG. 16), the spreading sequences may be configured as follows. Here, the spreading sequences may be configured by the base station or the terminal. When the spreading sequences are configured by the base station, the base station may transmit a signaling message, system information, or DCI including information on the configured spreading sequences.

When the length of the spreading sequence is L, L mutually-orthogonal spreading sequences may be generated. In this case, one modulated symbol may be transformed into L spread symbols, and L spread symbols may occupy L resource elements. In the case that the number of terminals performing non-orthogonal uplink transmissions using the same time-frequency resource is N, when N≤L, an orthogonal spreading sequence may be assigned to each of the terminals. Thus, the spreaders 1440 of the terminals may perform the spreading operation using the orthogonal spreading sequence. On the other hand, when N>L, L modulated symbols may be spread based on the orthogonal spreading sequences at a specific time, and (N−L) modulated symbols may be spread based on the non-orthogonal spreading sequences at the specific time. Here, among the N modulated symbols, L modulated symbols to which the orthogonal spreading sequences are applied may be determined based on the following schemes.

[symbol]

Among N modulated symbols, L modulated symbols to which the orthogonal spreading sequences are applied may be randomly selected. For example, when N terminals perform non-orthogonal uplink transmissions using the same time-frequency resources, the base station may randomly select L modulated symbols to which the orthogonal spreading sequences are to be applied, and inform the terminal of the orthogonal spreading sequences to be applied to L modulated symbols, the non-orthogonal spreading sequences to be applied to (N−L) modulated symbols, or the like. The terminals may confirm the spreading sequences to be applied to the modulated symbols based on the information received from the base station, and perform the spreading operations using the confirmed spreading sequences. In this case, the number of modulated symbols to which the orthogonal spreading sequences are applied in the terminals may be different from each other.

[symbol]

The orthogonal spreading sequences may be allocated such that the ratios (e.g., the numbers) of modulated symbols to which the orthogonal spreading sequences are applied in the terminals are as equal as possible. When the number of terminals performing non-orthogonal uplink transmissions using the same time-frequency resources is N and orthogonal spreading sequences are allocated to L modulated symbols among N modulated symbols, the orthogonal spreading sequences may be allocated such that the number of modulated symbols to which the orthogonal spreading sequences are applied is the same or similar. For example, when the total number of modulated symbols transmitted by each of the terminals is M, the base station may allocate orthogonal spreading sequences to (M×(L/N)) modulated symbols and non-orthogonal spreading sequences to (M×(1−L/N)) modulated symbols. The base station may transmit to the terminals information on the orthogonal spreading sequences allocated to (M×(L/N)) modulated symbols, information of the non-orthogonal spreading sequences allocated to (M×(1−L/N)) modulated symbols, or the like. Each of the terminals may identify the spreading sequences to be applied to the modulated symbols based on the information received from the base station, and perform spreading operations using the identified spreading sequences.

According to Scheme 2, the spreading sequences may be allocated as follows.

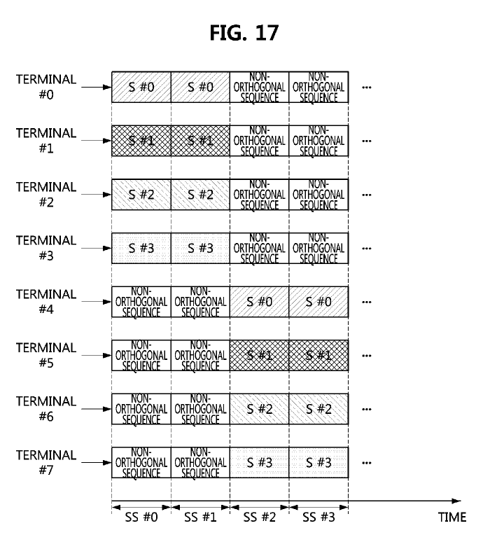

FIG. 17 is a conceptual diagram illustrating a third embodiment of a spreading based non-orthogonal uplink transmission method.

Referring to FIG. 17, a plurality of terminals (terminals #0 to #7) may perform uplink transmissions using the same time-frequency resources. Here, S #0, S #1, S #2, and S #3 may be orthogonal spreading sequences. The terminals #0 to #3 may perform spreading operations on the first modulated symbol (e.g., MS #0 corresponding to SS #0) and the second modulated symbol (e.g., MS #1 corresponding to SS #1) by using the orthogonal spreading sequences S #0 to S #3, and may perform spreading operations on the third modulated symbol (e.g., MS #2 corresponding to SS #2) and the fourth modulated symbol (e.g., MS #3 corresponding to SS #3) by using the non-orthogonal spreading sequences.

The terminals #4 to #7 may perform spreading operations on the first modulated symbol (e.g., MS #0 corresponding to SS #0) and the second modulated symbol (e.g., MS #1 corresponding to SS #1) by using the non-orthogonal spreading sequences, and may perform spreading operations on the third modulated symbol (e.g., MS #2 corresponding to SS #2) and the fourth modulated symbol (e.g., MS #3 corresponding to SS #3) by using the orthogonal spreading sequences S #0 to S #3. Therefore, the ratios of the modulated symbols to which the orthogonal spreading sequences are applied in the terminals #0 to #7 may be the same.

[symbol]

The base station may allocate spreading sequences considering channel qualities (e.g., channel state information) of the terminals participating in the uplink transmission procedure. For example, the base station may obtain channel state information (e.g., a channel quality indicator (CQI), a received signal strength indicator (RSSI), etc.) from each of the terminals, determine a channel quality of each of the terminals based on the channel state information, and allocate a relatively small number of orthogonal spreading sequences to terminals having good channel quality and allocate a relatively large number of orthogonal spreading sequences to terminals having poor channel quality.

For example, when the RSSI of the terminal #0 is larger than the RSSI of the terminal #1, the base station may allocate a larger number of orthogonal spreading sequences to the terminal #1 than the terminal #0. The base station may inform the terminals of allocated orthogonal spreading sequences, allocated non-orthogonal spreading sequences, or the like. The terminals may identify the spreading sequences to be applied to the modulated symbols based on the information received from the base station, and may perform the spreading operations using the identified spreading sequences.

Scheme 3 may be effective when the base station does not perform an interference cancellation operation (e.g., parallel interference cancellation (PIC), successive interference cancellation (SIC), or the like) for cancelling interferences between terminals, or when the base station performs the interference cancellation operation restrictedly. On the other hand, when the base station actively performs the interference cancellation operation for cancelling interferences between the terminals, the following Scheme 4 may be more effective.

[symbol]

When the number of terminals performing non-orthogonal uplink transmissions using the same time-frequency resources is N and spreading sequences of length L are used, the base station may configure (N/L) spreading groups, allocate L orthogonal spreading sequences to each of the (N/L) spreading groups, and allocate a specific sequence by which each of the (N/L) spreading groups is multiplied to each of the (N/L) spreading groups so that the spreading groups have non-orthogonality. Also, the base station may allocate the spreading groups to the terminals, such that the spreading group allocated to the terminal changes in units of symbol sets including a plurality of modulated symbols or in units of modulated symbols.

The base station may inform the terminal of spreading groups allocated to the symbol set or the modulated symbol, orthogonal spreading sequences belonging to the spreading groups, and the like. The terminals may identify the spreading sequences to be applied to the modulated symbols based on the information received from the base station, and may perform the spreading operations using the identified spreading sequences. In this case, orthogonal spreading sequences may be applied to some modulated symbols among all the modulated symbols, and non-orthogonal spreading sequences may be applied to the remaining modulated symbols.

According to Scheme 4, the spreading sequences may be allocated as follows.

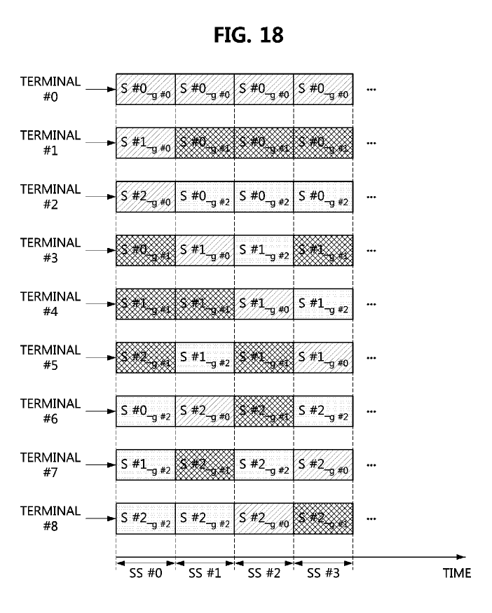

FIG. 18 is a conceptual diagram illustrating a fourth embodiment of a spreading based non-orthogonal uplink transmission method.

Referring to FIG. 18, a plurality of terminals (terminals #0 to #8) may perform non-orthogonal uplink transmissions using the same time-frequency resources. The spreading groups may be classified into a spreading group #0 (g #0), a spreading group #1 (g #1), and a spreading group #2 (g #2), each of the spreading groups may include orthogonal spreading sequences S #0, S #1, S #2, and S #3, and the spreading groups may be configured to be non-orthogonal. The orthogonal spreading sequences belonging to the spreading group #0 (g #0) may be referred to as S #0 _{—g#0}, S #1 _{—g #0}, and S #2 _{—g #0}, the orthogonal spreading sequences belonging to the spreading group #1 (g #1) may be referred to as S #0 _{—g #1}, S #1 _{—g #1}, and S #2 _{—g #1}, the orthogonal spreading sequences belonging to the spreading group #2 (g #2) may be referred to as S #0 _{g #2}, S #1 _{—g #2}, and S #2 _{—g #2}.

The terminals #0 to #2 may perform spreading operations on the first modulated symbol (e.g., MS #0 corresponding to SS #0) using the orthogonal spreading sequences belonging to the spreading group #0, and perform spreading operations on the remaining modulated symbols (e.g., MS #1 to MS #3 corresponding to SS #1 to SS #3) using non-orthogonal spreading sequences belonging to different spreading groups. The terminals #3 to #5 may perform spreading operations on the first modulated symbol (e.g., MS #0 corresponding to SS #0) using the orthogonal spreading sequences belonging to the spreading group #1, and perform spreading operations on the remaining modulated symbols (e.g., MS #1 to MS #3 corresponding to SS #1 to SS #3) using non-orthogonal spreading sequences belonging to different spreading groups. The terminals #6 to #8 may perform spreading operations on the first modulated symbol (e.g., MS #0 corresponding to SS #0) using the orthogonal spreading sequences belonging to the spreading group #2, and perform spreading operations on the remaining modulated symbols (e.g., MS #1 to MS #3 corresponding to SS #1 to SS #3) using non-orthogonal spreading sequences belonging to different spreading groups.

Reference Signal in Non-Orthogonal Uplink Transmission Procedure

In the non-orthogonal uplink transmission procedure, the terminal may transmit a reference signal together with uplink data. The base station may receive the reference signal from the terminal, estimate a radio channel between the base station and the terminal based on the reference signal, and demodulate the uplink data of the terminal based on the estimated radio channel. When the radio channel is accurately estimated based on the reference signal, the reception performance can be improved. Therefore, in the non-orthogonal uplink transmission procedure, it is preferable that the reference signal is transmitted through the orthogonal resource.

In order to allocate orthogonal resources for the reference signals, orthogonal resources as many as the number of terminals participating in the non-orthogonal uplink transmission procedure may be required. Also, the number of orthogonal resources for the reference signals may increase in proportion to the number of terminals participating in the non-orthogonal uplink transmission procedure. When the number of terminals participating in the non-orthogonal uplink transmission procedure is very large, orthogonal resources for the reference signals may not be allocated. In this case, the reference signals may be transmitted based on a code division multiplexing (CDM) scheme. The transmission of the reference signals based on the CDM scheme may have the following features.

Feature 1: terminals can perform uplink transmissions using the same time-frequency resources.

Feature 2: A reference sequence used for the transmission of the reference signal may be determined by the terminal or the base station. When the reference sequence is determined by the base station, the base station may inform the terminal of the determined reference sequence, and the terminal may use the reference sequence obtained from the base station.

Feature 3: The reference sequences used by terminals participating in the non-orthogonal uplink transmission procedure may be orthogonal or non-orthogonal.

For example, reference sequences may be classified into two reference groups (e.g., a reference group #0 and a reference group #1), the orthogonal CDM may be applied to reference sequences belonging to the reference group #0 so that there may be no interference between the reference sequences belonging to the reference group #0, and the orthogonal CDM may be applied to reference sequences belonging to the reference group #1 so that there may be no interference between the reference sequences belonging to the reference group #1. On the other hand, one reference sequence belonging to the reference group #0 may be non-orthogonal to all reference sequences belonging to the reference group #1, and one reference sequence belonging to the reference group #1 may be non-orthogonal to all reference sequences belonging to the reference group #0. That is, a reference signal generated based on one reference sequence belonging to a specific reference group may experience interference by a reference signal generated based on a reference sequence belonging to another reference group.

Meanwhile, the reference sequence may be mapped in a one-to-one manner to the spreading sequence described above. Therefore, when a spreading sequence to be used for transmission of uplink data in the non-orthogonal uplink transmission procedure is determined, a reference sequence for transmission of a reference signal (e.g., a reference sequence mapped to the spreading sequence) may also be determined. The spreading sequence and the reference sequence may be determined by the terminal or the base station. When the spreading sequence and the reference sequence are determined by the base station, the base station may inform the terminal of the determined spreading sequence and reference sequence. Also, the reference sequence may be configured based on a sequence hopping scheme.

The reference sequences may have a base sequence and may be configured to be orthogonal by applying phase rotations. The reference sequences belonging to the same reference group may have the same base sequence, and the reference sequences belonging to the same reference group may be configured to be orthogonal by applying different phase rotations to the reference sequences. The reference sequences belonging to different reference groups may use different base sequences, and the different base sequences may be designed to have low cross-correlation characteristics. When the different base sequences have low cross-correlation characteristics, an effect of randomizing interferences may be achieved.

The reference sequence may be defined as shown in Equation 4 below.

r_{q}^{(α)}(n)=e^{jan}r̅_{q}(n), 0≤n<M^{RS} [Equation 4]

Here, r_{q}^{(α)}(n) may indicate the reference sequence, r̅_{α}(n) may indicate the base sequence, α may indicate a cyclic shift value, M^{RS} may indicate the length of the reference sequence, and q may indicate the reference group. A plurality of reference sequences r_{q}^{(α)}(n) may be obtained by applying different cyclic shift values a to the base sequence r̅_{α}(n). The reference sequences r_{q}^{(α)}(n) belonging to the same reference group may be generated based on the same base sequence r̅_{α}(n) and different cyclic shift values α. In this case, the reference sequences r_{q}^{(α)}(n) belonging to the same reference group may be orthogonal, and the following Equation 5 may be defined.

$${\sum }_{n = 0}^{{M}^{RS} - 1} {r}_{q}^{a 1} ( n ) \cdot {r}_{q}^{a 2} ( n ) = {M}^{RS} \cdot {δ}_{a 1 , a 2} \qquad [ Equation 5 ]$$

The different base sequences used in the reference groups may satisfy Equation 6 below. Here, q₁ may indicate the reference group #1, and q₂ may indicate the reference group #2.

$$\vert {\sum }_{n = 0}^{{M}^{RS} - 1} {r}_{q 1}^{a 1} ( n ) \cdot {r}_{q 2}^{a 2} ( n ) \vert \approx \sqrt{{M}^{RS}} \qquad [ Equation 6 ]$$

Power Control Method

When the terminals participating in the non-orthogonal uplink transmission procedure using the same time-frequency resource are classified into a plurality of groups, and sequences (e.g., spreading sequence, reference sequence) configured for each of the plurality of groups are non-orthogonal, a reception power (or transmission power) may be configured differently for each group in order to apply the SIC to signals of the terminals belonging to different groups. The reception power may indicate a power of a signal received at the base station, and the transmission power may indicate a power of a signal transmitted from the terminal. For example, the base station may configure a reception power P _{#0} of the group #0, a reception power P _{#1} of the group #1, and a reception power P _{#2} of the group #2. Alternatively, each of P _{#0}, P_{#1}, and P_{#2} may indicate a transmission power of the group #0, a transmission power of the group #1, and a transmission power of the group #2.

P_{#0}>P_{#1}P_{#2} [Equation 7]

When the reception powers (or transmission powers) of the groups (i.e., the groups #0 to #2) are configured as shown in Equation 7 and the entire signal including the signal of terminal #0 belonging to the group #0, the signal of the terminal #1 belonging to the group #1, and the signal of the terminal #2 belonging to the group #2 is received through the same time-frequency resource, the base station may first detect the signal of the terminal #0 from the entire signal, and decode data of the terminal #0 from the signal of the terminal #0. Then, the base station may detect the signal of the terminal #1 by removing the signal of the terminal #0 from the entire signal, and may decode data of the terminal #1 from the detected signal of the terminal #1. Then, the base station may detect the signal of the terminal #2 by removing the signal of the terminal #0 and the signal of the terminal #1 from the entire signal, and may decode data of the terminal #2 from the detected signal of the terminal #2. In this case, when the terminals belonging to each of the groups transmits an orthogonal reference signal (i.e., an orthogonal reference sequence), interferences between terminals belonging to different groups can be reduced, and only interference from terminals belonging to other groups that are not removed in the entire signal may exist.

The reception power (or transmission power) per group may be configured by the base station, and the reception power (or transmission power) may be used for data transmission as well as reference signal transmission. The transmission power of the terminal belonging to the group g may be set based on the following Equation 8.

P_{Tx}^{g}=min{Pₘₐₓ, 10 log₁₀(M)+P₀^{g}+α·PL+f_{cl}}(dBm) [Equation 8]

Here, P_{Tx}^{g} may indicate the transmission power of the terminal, Pₘₐₓ may indicate the maximum transmission power, and M may indicate the number of resource blocks used by the terminal for uplink transmission. Also, P₀^{g} may indicate the expected value of the reception power per resource block per group configured by the base station. For example, the expected value P₀^{g0} of the reception power of the terminal belonging to the group #0, the expected value P₀^{g1} of the reception power of the terminal belonging to the group #1, and the expected value P₀^{g2} of the reception power of the terminal belonging to the group #2 may be configured to satisfy Equation 9 below.

P₀^{g0}>P₀^{g1}>P₀^{g2} [Equation 9]

In Equation 8, α may be an arbitrary constant, and PL may indicate a downlink path loss estimated by the terminal, which may be set based on Equation 10 below.

PL=P_{RS}−RSRP [Equation 10]

Here, the PRS may indicate the transmission power per unit resource of the reference signal transmitted by the base station, and a reference signal received power (RSRP) may indicate the reception power of the reference signal per unit resource. In Equation 8, f_{d} may indicate a power adjustment value per resource block configured by the base station. The base station may inform the terminal of f_{d}. When f_{d} is not configured by the base station, the terminal may assume that f_{d} is zero.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a terminal for uplink transmission in a communication network based on Internet of things (IoT), the operation method comprising:
receiving a message including information on a resource pool for the uplink transmission from a base station included in the communication network;
configuring an uplink resource for the uplink transmission based on the resource pool;
transmitting a message including a transmission indicator indicating the uplink transmission to the base station based on a transmission indicator pool corresponding to the resource pool; and
performing the uplink transmission through the uplink resource based on a plurality of parameters preconfigured for the uplink transmission.

2. The operation method according to claim 1, wherein the message including information on a resource pool is received from the base station through a radio resource control (RRC) signaling.

3. The operation method according to claim 1, wherein the resource pool includes time-frequency resources available for the uplink transmission of the terminal.

4. The operation method according to claim 1, wherein the plurality of parameters include a timing of the uplink transmission, a transmission power of the uplink transmission, a size of a payload of the uplink transmission, and a modulation and coding scheme (MCS) for the uplink transmission.

5. The operation method according to claim 1, wherein the plurality of parameters are preconfigured by the base station, or at least one parameter among the plurality of parameters is configured by the terminal.

6. The operation method according to claim 5, wherein the at least one parameter includes at least one of a timing of the uplink transmission, a transmission power of the uplink transmission, and a size of a payload of the uplink transmission.

7. The operation method according to claim 1, wherein the transmitting comprises:
selecting a transmission indicator resource for transmission of the transmission indicator in the transmission indicator pool; and
transmitting the message including the transmission indicator to the base station through the transmission indicator resource.

8. The operation method according to claim 1, wherein the transmission indicator pool is acquired from the base station, and includes time-frequency resources available for transmission of the transmission indicator.

9. The operation method according to claim 1, wherein the operation method is performed periodically according to a periodicity preconfigured by the base station, or performed when the uplink transmission is necessary.

10. An operation method of a base station for uplink transmission in a communication network based on Internet of things (IoT), the operation method comprising:
generating a resource pool for uplink transmission of a terminal included in the communication network and a transmission indicator pool corresponding to the resource pool;
transmitting a message including information on the resource pool and information on the transmission indicator pool to the terminal;
receiving a message including a transmission indicator indicating the uplink transmission from the terminal; and
supporting the uplink transmission of the terminal based on an uplink resource included in the resource pool and a plurality of parameters preconfigured for the uplink transmission.

11. The operation method according to claim 10, wherein the resource pool includes time-frequency resources available for the uplink transmission.

12. The operation method according to claim 10, wherein the plurality of parameters include a timing of the uplink transmission, a transmission power of the uplink transmission, a size of a payload of the uplink transmission, and a modulation and coding scheme (MCS) for the uplink transmission.

13. The operation method according to claim 10, wherein the plurality of parameters are preconfigured by the base station, or at least one parameter of a timing of the uplink transmission, a transmission power of the uplink transmission, and a size of a payload of the uplink transmission is configured by the terminal among the plurality of parameters.

14. The operation method according to claim 10, wherein the supporting comprises:
identifying an uplink resource indicated by the transmission indicator in the resource pool; and
receiving a message including data from the terminal through the identified uplink resource based on the plurality of parameters.

15. The operation method according to claim 10, wherein the operation method is performed periodically according to a periodicity preconfigured by the base station, or performed when the uplink transmission is necessary at the terminal.

16. An operation method of a terminal for uplink transmission in a communication network based on Internet of things (IoT), the operation method comprising:
receiving a downlink control information (DCI) transmitted from a base station included in the communication network;
identifying a terminal group indicated by the DCI based on scrambling of the DCI; and
performing uplink transmission of the terminal when the identified terminal group is a terminal group to which the terminal belongs.

17. The operation method according to claim 16, wherein the identifying comprises:
descrambling the DCI based on an identifier of the terminal group to which the terminal belongs; and
identifying the terminal group indicated by the DCI based on a result of the descrambling.

18. The operation method according to claim 17, wherein the identifier of the terminal group is a radio network temporary identifier (RNTI) of the terminal group.

19. The operation method according to claim 16, wherein the performing uplink transmission comprises:
identifying an uplink resource for the uplink transmission of the terminal from the DCI; and
performing the uplink transmission of the terminal through the identified uplink resource based on a plurality of parameters preconfigured for the uplink transmission of the terminal.

20. The operation method according to claim 19, wherein the plurality of parameters include a signature used for the uplink transmission of the terminal, a transmission power of the uplink transmission of the terminal, a size of a transport block for the uplink transmission of the terminal.
